(19) United States
(12) Patent Application Publication
(10) Pub. No.: US 2008/0158388 A1
(43) Pub. Date: Jul. 3, 2008

(54) REMOVABLE STORAGE DEVICE PROVIDING AUTOMATIC LAUNCH CAPABILITY IN AN IMAGE PROCESSING SYSTEM

(76) Inventors: Tomi Lahcanski, Rochester, NY (US); Joseph P. Lentz, Kendall, NY (US)

Correspondence Address: Frank Pincelli;Patent Legal Staff, Eastman Kodak Company, 343 State Street, Rochester, NY, 14650-2201, US

(21) Appl. No.: 11/616,333

(22) Filed: Dec. 27, 2006

(51) Int. Cl. H04N 5/76

(52) U.S. Cl. 348/231.7

(57) ABSTRACT

A removable storage device configured for use with a digital camera, computer or other processing device of an image processing system includes a first storage area configured for storing digital images, and a second storage area partitioned from the first storage area. The second storage area is configured for storing user-customized application information for directing the processing of one or more of the stored digital images by the processing device upon insertion of the removable storage device in a reader associated with the processing device.

### FIELD OF THE INVENTION

The present invention relates generally to image processing systems, and more particularly to memory cards and other types of removable storage devices for use with a digital camera, computer or other processing device of an image processing system.

### BACKGROUND OF THE INVENTION

Many digital cameras are configured to utilize memory cards or other types of removable storage devices. In a typical conventional arrangement, a digital camera includes a memory card slot adapted for insertion of a memory card. Digital images captured by the digital camera are stored in the memory card. The memory card can then be removed from the digital camera and inserted into a memory card slot associated with a computer, such that the computer can be used to view, print, archive, email, upload or otherwise process the images stored on the card.

A problem that can arise in a conventional arrangement of the type described above is that it becomes difficult to manage the various cards on which different sets of captured images may be stored. For example, each time a given card is inserted in a computer, the user may have to specify the particular processing operations that are desired for the images stored on that card. This is true even though the particular card may be one which the user always utilizes to store the same types of images and for which the user would generally like to initiate the same processing operations each time the card is inserted in the computer.

The above-described problem is not adequately addressed by conventional arrangements, such as the networked appliance described in U.S. Pat. No. 6,571,271 to Savitzky et al., entitled “Networked Appliance for Recording, Storing and Serving Digital Images.” A networked appliance of this type utilizes an internal image handler to read stored images from a memory card that is inserted into a card slot of the networked appliance. The specific instructions for handling the images stored on the card are contained entirely within the networked appliance. Such an approach is inefficient in that it requires a networked appliance that is configured in a particular manner in order to provide the desired processing operations for the images stored on the card. Accordingly, the user must always have access to the particular networked appliance that contains the corresponding instructions for the images stored on the memory card. If the networked appliance that stores the particular image handling instructions needed at a given point in time is not available, the user will have to enter his or her processing preferences manually, for example, using a different networked appliance or a general-purpose computer.

It is therefore apparent that a need exists for improved techniques for processing digital images stored on memory cards and other removable storage devices, which avoid the drawbacks of the above-described conventional approaches.

### SUMMARY OF THE INVENTION

It is an object of the present invention to provide improved techniques for processing digital images stored on removable memory cards and other removable storage devices.

This object is achieved in one aspect of the invention by a removable storage device that is configured for use with a digital camera, computer or other processing device of an image processing system. The removable storage device includes a first storage area configured for storing digital images, and a second storage area partitioned from the first storage area. The second storage area is configured for storing user-customized application information for directing the processing of one or more of the stored digital images by the processing device upon insertion of the removable storage device in a reader associated with the processing device.

The second storage area may comprise, for example, a cloaked memory that is not otherwise accessible to an operating system of the processing device without first providing at least a portion of the application information to the processing device. Such a cloaked memory may comprise, again by way of example, a private block of the removable memory card, with a first sector of the private block beginning at an address given by a value of a reported total number of sectors of the storage device.

In an illustrative embodiment, the application information stored in the second storage area of the removable storage device comprises information identifying at least one particular processing operation that is previously selected by a user so as to be automatically applied to one or more of the stored images by the processing device. Such processing operations may comprise, for example, a storing operation, a printing operation, an emailing operation, an online sharing operation, etc.

The particular processing operation may be designated for application to only those of the stored images that are associated with one or more specified sessions for which corresponding stored images have not been previously processed in conjunction with a prior insertion of the storage device in a reader.

Advantageously, the storage of user-customized application information in a partitioned area of the removable storage device considerably facilitates the implementation of image processing operations for the corresponding stored images. Also, a removable storage device in accordance with the illustrative embodiment can be used with any computer or other processing device, thereby avoiding the drawbacks of the conventional networked appliance approach described above.

### BRIEF DESCRIPTION OF THE DRAWINGS

FIG. 1 is a block diagram of an image processing system;

FIG. 2 is a block diagram of a digital camera used in the image processing system of FIG. 1;

FIG. 3 depicts a removable memory card used in the image processing system of FIG. 1;

FIG. 4 is a flow diagram of an automatic launch process implemented in the image processing system of FIG. 1;

FIGS. 5 and 6 show examples of respective set-up and options screens that may be presented to a user in conjunction with the automatic launch process of FIG. 4;

FIGS. 7, 8 and 9 show examples of various instances of the automatic launch process of FIG. 4; and

FIGS. 10A and 10B are tables showing one possible configuration for portions of a cloaked memory storage area within the removable memory card of FIG. 3.

### DETAILED DESCRIPTION OF THE INVENTION

The present invention will be illustrated herein in conjunction with particular embodiments of image processing systems, removable storage devices, automatic launch processes and other elements. It should be understood, however, that these illustrative arrangements are presented by way of example only, and should not be viewed as limiting the scope of the invention in any way. Those skilled in the art will recognize that the disclosed techniques can be adapted in a straightforward manner for use with a wide variety of other image processing systems, removable storage devices, automatic launch processes, etc.

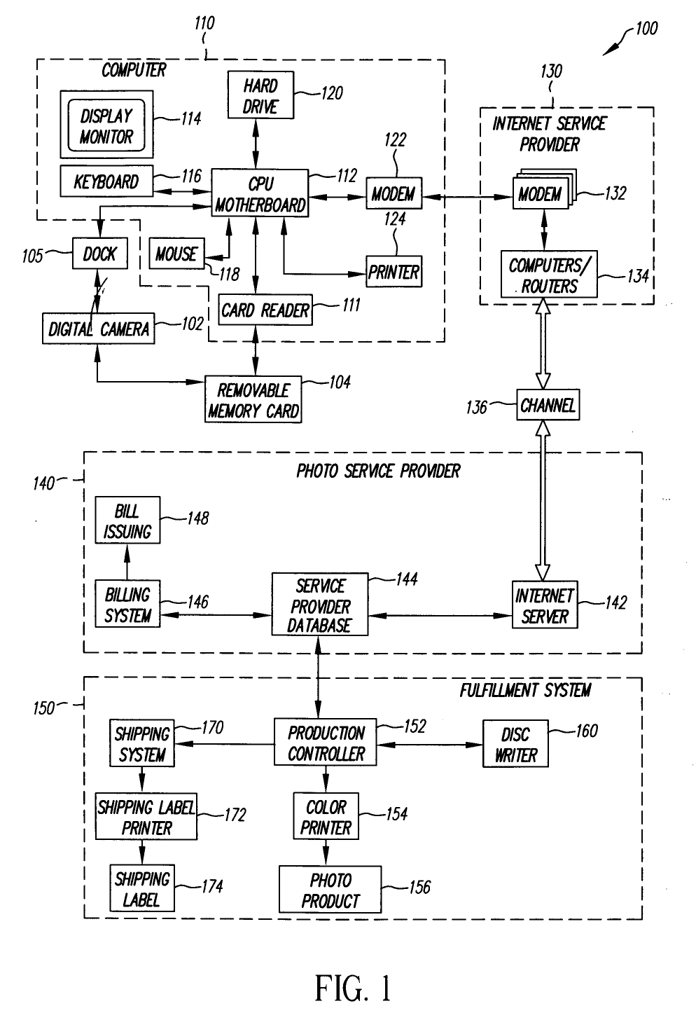

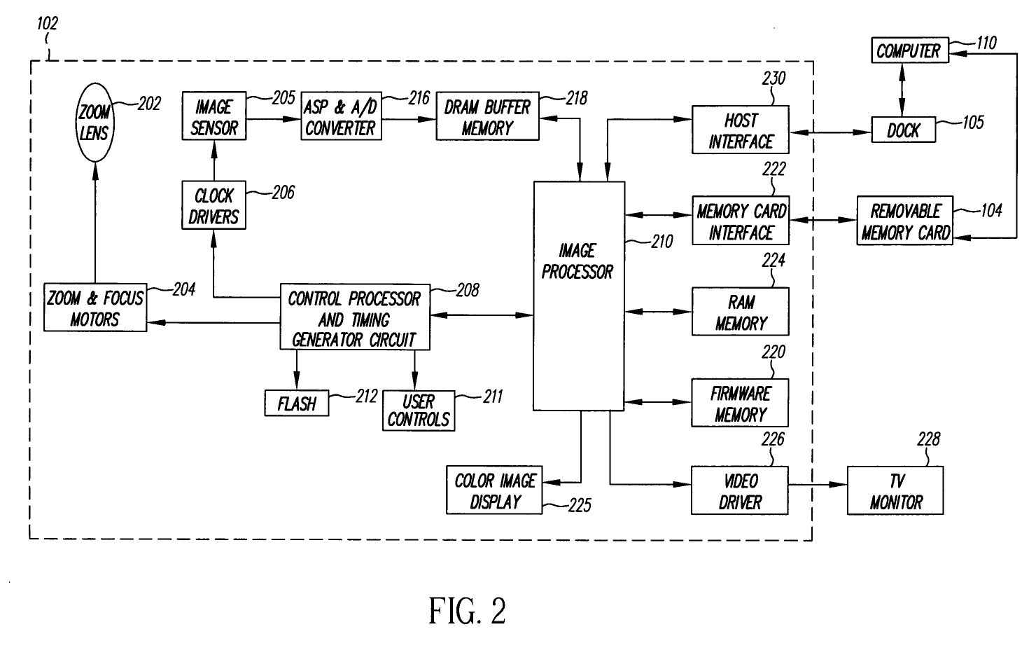

FIG. 1 shows an image processing system 100 in accordance with an illustrative embodiment of the invention. The system 100 includes a digital camera 102 that captures still and motion video images, as will be described in greater detail below with reference to FIG. 2. The digital camera is configured to utilize a removable memory card 104 for storage of captured digital images. The digital camera is coupled via a dock 105 to a computer 110. The computer 110 can communicate with the digital camera 102 when the digital camera is placed in dock 105. The dock 105 can be used, for example, to transfer images and control files between the digital camera and the computer, and to recharge the batteries in the digital camera 102. Numerous other mechanisms may be used to couple the digital camera to the computer, including, for example, a universal serial bus (USB) cable, a wireless connection, etc.

The digital camera 102 is one example of an imaging device that can be used in an image processing system in accordance with the present invention. Other examples of imaging devices include still-only or motion video-only cameras, and combination cell phone/digital cameras that can capture and transmit digital still and/or video images.

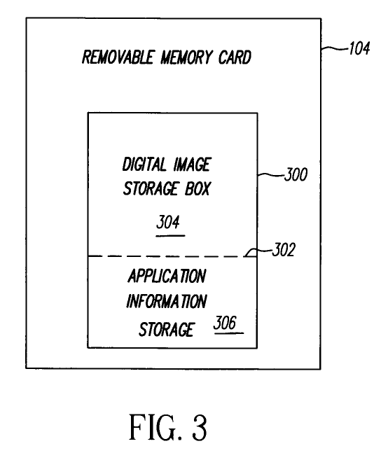

The removable memory card 104 may be viewed as an example of what is more generally referred to herein as a removable storage device. As will be described below in conjunction with FIG. 3, the removable memory card 104 is configured with a partitioned memory that facilitates implementation of an automatic launch function when the card is inserted into a card reader 111 of the computer 110. The removable memory card can include, for example, a NAND Flash memory or NOR Flash memory, or another type of non-volatile solid-state memory. Other types of removable storage devices that may be used include, for example, magnetic memory such as a hard disk, or optical memory.

The computer 110 may represent, for example, a home computer or a kiosk. In alternative embodiments, other types of processing devices, such as a television set-top box or an Internet appliance, could be used in place of the computer 110. The card reader 111 may be internal to a housing of the computer, or may be implemented as a peripheral coupled to the computer via a wired or wireless connection, or may be otherwise associated with the computer. A given card reader can include a single-slot reader, or a multiple-slot reader.

The computer 110 in this embodiment includes well-known conventional elements such as a central processing unit (CPU) motherboard 112, a display monitor 114, a keyboard 116, a mouse 118, a hard drive 120, a modem 122 and a printer 124. The CPU motherboard can include, for example, an Intel Pentium IV processor as well as random access memory (RAM) and read-only memory (ROM), although such elements are not explicitly shown in the figure. The CPU motherboard 112 executes software stored on the hard drive 120, for example, the well-known Windows XP operating system software and the Internet Explorer web browser software, both provided by Microsoft Corp. of Redmond, Wash. The hard drive 120 is also used to store application software that can be provided along with the digital camera 102 using any suitable software distribution media or method, such as a CD-ROM, floppy disc, or Internet download, as is well-known to those skilled in the art. The hard drive 120 may also be used to store images captured by the digital camera 102 and to store a local database of information associated with these images. Other types of memory that may be utilized by the computer 110 include, for example, optical discs, Flash drives, etc.

The computer 110 utilizes modem 122 to communicate with an Internet service provider (ISP) 130. The ISP 130 includes modems 132 and computers and/or routers 134 which are used to establish a connection between the computer 110 and a channel 136, such as the Internet. The computer 110 can utilize such a connection to email images to designated recipients or to provide images to a photo service provider 140. The photo service provider 140 is coupled to a fulfillment system 150 as shown.

The channel 136 in this embodiment provides a connection to an Internet server 142 of the photo service provider 140. A service provider database 144 at the photo service provider 140 provides information describing numerous photo products that can be provided by the fulfillment system 150, as described in commonly-assigned U.S. Pat. No. 6,915,273 to Parulski et al., entitled “Method for Providing Customized Photo Products Over a Network Using Images Captured From a Digital Camera,” the disclosure of which is incorporated herein by reference.

The service provider database 144 includes information describing each customer account, including user billing information. The billing information can include a payment identifier for the user, such as a charge card number, expiration date, and user billing address. Such information is utilized by a billing system 146 which performs bill issuing 148. The service provider database 144 can optionally provide long-term storage of images uploaded from the computer 110. In this case, stored images are accessible (e.g., viewable) via the Internet by authorized users, as described, for example, in commonly-assigned U.S. Pat. No. 5,760,917 to Sheridan, entitled “Image Distribution Method and System,” the disclosure of which is incorporated herein by reference. The service provider database 144 can be provided by the same computer as Internet server 142, or can utilize a separate computer, or can be distributed over several computers at the same physical site, or at different sites.

The photo service provider 140 communicates with the fulfillment system 150, which is included of one or more computers and associated peripherals for producing photo products, such as hardcopy prints, album pages, photo mugs, Kodak PictureCD discs, and the like. The fulfillment system 150 includes a computer that serves as a production controller 152, and controls one or more color printers 154, which can produce photo products 156 such as album pages or standard hardcopy prints of various sizes. The production controller 152 is also connected to a disc writer 160, which can produce CDs or DVDs, for example Kodak PictureCDs, having digital still and video images and application software for using the digital images. The production controller 152 can optionally be connected to devices (not shown) for producing other types of photo products 156, for example, t-shirts or coffee mugs, incorporating one or more images uploaded from the computer 110.

The production controller 152 also controls a shipping system 170, which controls a shipping label printer 172 to produce a shipping label 174. The shipping label 174 is attached to a shipping container (e.g., a cardboard box containing packing material) that contains and protects the photo product 156 during shipment (e.g., via air express mail or ground carrier) to the user or the user's designee.

On a regular basis (e.g., monthly), or alternatively, whenever a photo product 156 is purchased by the user, the service provider database 144 communicates with the billing system 146 to verify that the payment identifier (e.g., credit card or debit card number) provided by the customer is valid, and to debit the account for the purchase or for a monthly service fee for providing information to the user and storing user images. As shown in block 148, the bill is issued. The customer's account that is debited can, of course, be located at a remote financial institution.

The digital camera 102 is shown in block diagram form in FIG. 2. Preferably, the digital camera 102 is a portable battery operated device, small enough to be easily handheld by a user when capturing and reviewing images. The digital camera 102 can be, for example, a Kodak EasyShare DX4330 Zoom Digital Camera. The digital camera 102 produces digital images that are stored on the removable memory card 104. The digital camera 102 includes a zoom lens 202 having zoom and focus motor drives 204 and an adjustable aperture and shutter (not shown). The zoom lens 202 focuses light from a scene (not shown) on an image sensor 205, for example, a single-chip color charge-coupled device (CCD) image sensor, using the well-known Bayer color filter pattern. The image sensor 205 is controlled by clock drivers 206. The image sensor 205 can have, for example, 3.3 megapixels (2242×1473 pixels), although numerous other resolutions could be used. The zoom and focus motors 204 and the clock drivers 206 are controlled by control signals supplied by a control processor and timing generator circuit 208. The control processor and timing generator circuit 208 receives inputs from an image processor 210, which provides calculations for focus and exposure determination, and from user controls 211. The user controls 211 may include, for example, a switch having four-way control buttons (up, down, left, right) and a push-button center button, a zoom lens control rocker switch, a shutter button, a mode dial, etc. Numerous other arrangements of switches and buttons may be used to implement user controls 211. The control processor and timing generator circuit 208 also controls a flash 212.

The analog output signal from the image sensor 205 is amplified and converted to digital data by the analog signal processing (ASP) and analog-to-digital (A/D) converter circuit 216. The digital data is stored in a DRAM buffer memory 218 and subsequently processed by image processor 210 controlled by firmware stored in firmware memory 220, which can be Flash EPROM memory.

The processed digital image file is provided to a memory card interface 222, which stores the digital image file on the removable memory card 104. As noted above, removable memory card 104 is one type of removable storage medium that may be used in implementing the invention. The card may be configured in accordance with a standard physical format, such as one of the well-known PCMCIA, Compact Flash, SmartMedia, MMC or SD memory card formats. Other types of removable digital image storage media, such as magnetic hard drives, magnetic tape, or optical disks, can also be used to store digital images in the system 100.

The processor 210 performs color interpolation followed by color and tone correction, in order to produce rendered sRGB image data. The processor 210 can also provide various image sizes selected by the user, for example, 3.1 megapixel (MP) “best quality” images, 2.2 MP “better quality” images, 0.8 MP “e-mail quality” images, and 0.4 MP “web quality” images. The rendered sRGB image data is then JPEG compressed and stored as a JPEG image file on the removable memory card 104. The JPEG file may use, for example, the so-called “Exif” image format defined in “Digital Still Camera Image File Format (Exif)” version 2.1, July 1998 by the Japan Electronics Industries Development Association (JEIDA), Tokyo, Japan. This format includes an Exif application segment that stores particular image metadata, for example, the date and time the picture was captured, the lens f/number and other camera settings, and image captions or comments that can be selected or entered by the camera user. The control processor and timing generator circuit 208 also provides a real-time clock value to the image processor 210, which can store this value as date/time metadata in each image file.

The processor 210 also creates a low-resolution “thumbnail” size image, which can be created as described in commonly-assigned U.S. Pat. No. 5,164,831 to Kuchta et al., entitled “Electronic Still Camera Providing Multi-Format Storage of Full and Reduced Resolution Images,” the disclosure of which is incorporated herein by reference. For example, the thumbnail image may have a resolution of 160×120 pixels, or other suitable resolution, and is stored in RAM memory 224 and supplied to a color LCD image display 225. After images are captured, they can be quickly reviewed on the color LCD image display 225 by using the thumbnail image data. A graphical user interface displayed on the color LCD image display 225 is controlled by user controls 211. The digital camera 102 can also include a video output driver 226 for displaying the captured images and the graphical user interface on a separate TV monitor 228.

The digital camera 102 includes a host interface 230 for coupling the camera to computer 110 via dock 105. As indicated previously, in other embodiments the connection between camera 102 and computer 110 may be via a USB cable, a Bluetooth connection, an IEEE 802.11 connection, or other type of wired or wireless connection. The interface 230 can be used to download images from removable memory card 104 to the computer 110, instead of using card reader 111 of FIG. 1. The interface 230 can also be used to transfer data from the computer 110 to the firmware memory 220 in the digital camera 102. By way of example, it can be used to transfer a user name and e-mail addresses from the computer 110 to the firmware memory 220, as described in commonly-assigned U.S. Pat. No. 6,573,927 to Parulski et al., entitled “Electronic Still Camera for Capturing Digital Image and Creating a Print Order,” the disclosure of which is incorporated herein by reference.

The digital camera 102 can include additional user controls for selecting one or more categories for images to be captured, as described in commonly-assigned U.S. Pat. No. 5,633,678 to Parulski et al., entitled “Electronic Still Camera For Capturing And Categorizing Images,” the disclosure of which is incorporated herein by reference. Alternatively or additionally, the stored digital images can be organized later when they are transferred to the computer using appropriate software.

The particular image processing system and digital camera elements shown in FIGS. 1 and 2 are presented by way of example only, and those skilled in the art will recognize that numerous alternative arrangements of elements may be used in implementing the invention.

FIG. 3 shows the manner in which the memory of removable storage card 104 is partitioned in an illustrative embodiment of the invention. As shown, a memory 300 of removable memory card 104 is partitioned as indicated by partition 302 into two areas, namely, a digital image storage area 304 and an application information storage area 306. The digital image storage area 304 is configured for storing digital image files captured by the digital camera 102. The application information storage area 306 is configured for storing user-customized application information for directing the processing of one or more of the stored digital image files by the computer 110 upon insertion of the removable memory card 104 in the card reader 111 of the computer 110. This capability is referred to in the context of the illustrative embodiment as automatic launch or simply autolaunch. The application information can include, for example, software applications, device drivers, or other information directing performance of particular processing operations, in any combination. Such application information in one or more of the illustrative embodiments is customized for a given user through user selection of one or more processing operations to be applied to image files stored on the card after the card is inserted in the card reader.

As one possible example of a partitioning of the type shown in FIG. 3, a given memory card having X bytes of memory may utilize the first X-n bytes of the memory for the digital image storage area 304, and the last n bytes of the memory for the application information storage area 306. Thus, an otherwise conventional 512 megabyte (MB) memory card may utilize, for example, 510 MB of the memory for image storage and 2 MB of the memory for application information storage. Such a memory card may have an advertised storage capacity of 510 MB, with this advertised storage capacity being printed on the memory card, for example, using a label affixed to the card. The additional 2 MB of memory is not considered part of the normal available image storage space of the memory card, and is not included as part of the advertised storage capacity of the card. As another example, a memory card with an advertised storage capacity of 1 gigabyte (GB) may actually be a 2 GB memory card, with 1 GB available for image storage and the remaining 1 GB not accessible for image storage but instead used for other purposes of the type described herein.

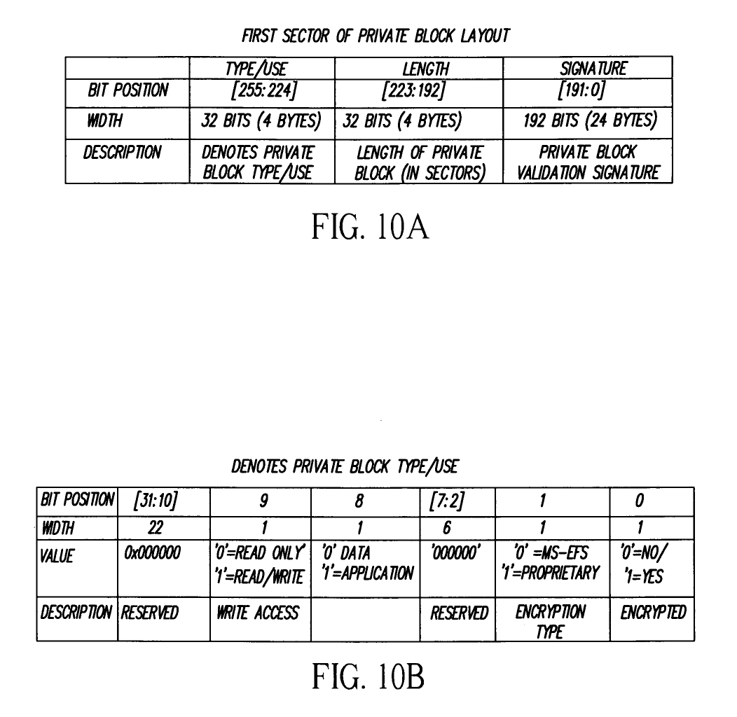

In this illustrative embodiment, the application information storage area 306 is a hidden storage space, also referred to herein as a cloaked memory space, that is not otherwise accessible to the computer 110 absent provision of the application information to the computer 110. Additional details regarding one possible configuration of the cloaked memory will be described below in conjunction with FIGS. 10A and 10B.

It should be noted that the partition 302 as shown is simplified for clarity of illustration. In this embodiment, the memory 300 is partitioned into two contiguous areas, but the invention is not limited to this particular type of partition. Other embodiments may utilize, for example, a more complex partitioning which utilizes multiple non-contiguous portions of the memory 300 for each of the separate areas 304 and 306.

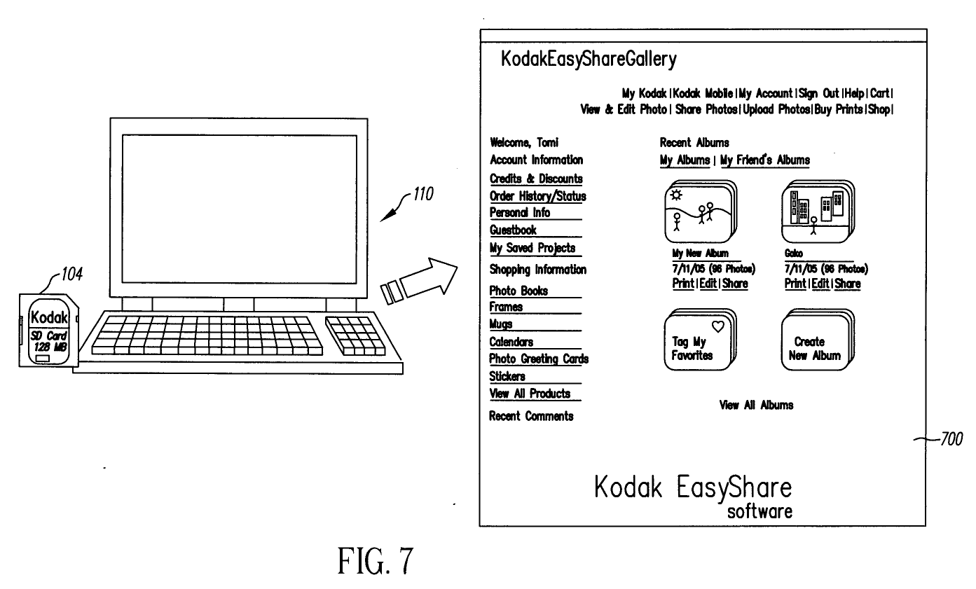

The application information stored in the application information storage area 306 can include, for example, information identifying particular ones of the images stored on the card 104 that are to be processed by the computer 110, and/or information identifying a particular processing operation that is to be applied to one or more of the stored images by the computer 110. Such processing operations can include, for example, a storing operation, a printing operation, an emailing operation, an online sharing operation, etc. Thus, upon insertion of a given removable memory card 104 in the card reader 111, the computer 110 can automatically initiate performance of particular processing operations on all or a subset of the images stored on the card. More detailed examples of this autolaunch capability will be described below in conjunction with FIGS. 7, 8 and 9. The application information that specifies the processing operations to be performed is stored on the removable card itself, which avoids problems such as those associated with the conventional network appliance approach previously described herein.

The cloaked memory space of the memory card 104 may also or alternatively store information other than application information. Such information may include, for example, documents or other information subject to password protection or other types of access control.

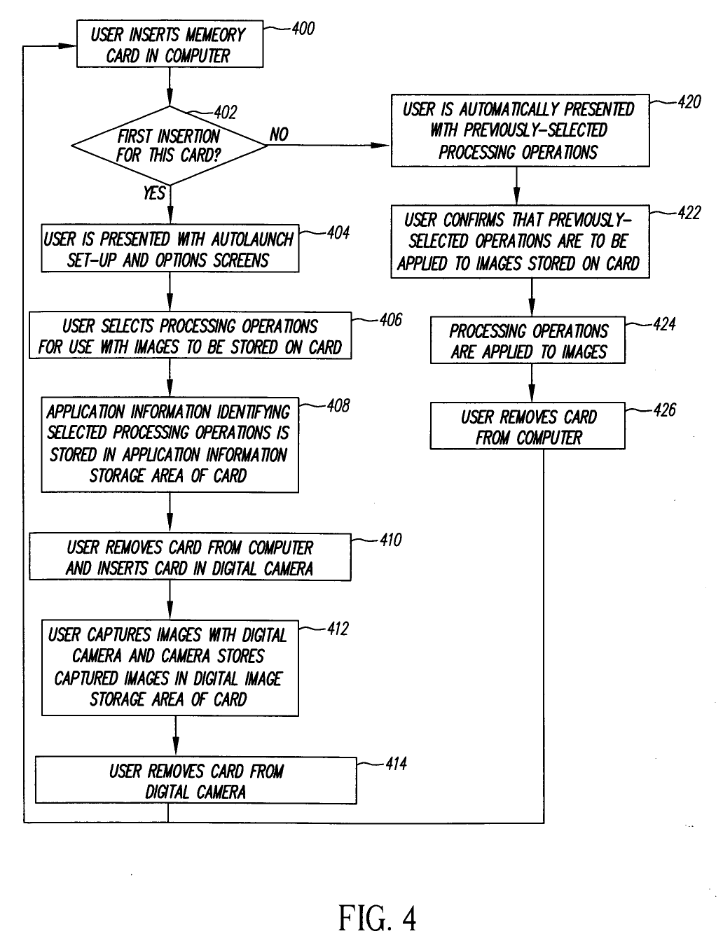

An exemplary automatic launch process that is implemented in system 100 of FIG. 1 will now be described with reference to the flow diagram of FIG. 4. In step 400, a user inserts the removable memory card 104 into card reader 111 of computer 110. If this is the first insertion for the particular memory card, as determined in step 402, the user is presented with an autolaunch set-up screen and one or more options screens via the display monitor 114 of the computer 110, as indicated in step 404. These screens and others described herein may be obtained by computer 110 via a connection established over channel 136 with Internet server 142 of the photo service provider 150.

It should be noted that a given set-up screen in the present embodiment is automatically launched upon insertion of the memory card into the reader.

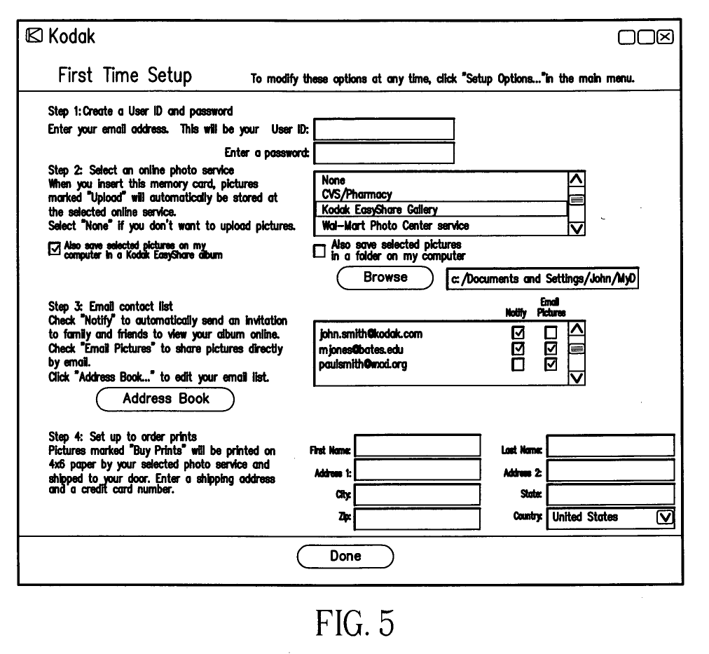

One possible example of a set-up screen that may be presented to the user in step 404 is the First Time Setup web page shown in FIG. 5, which includes user-controlled operations for creating a user identifier (e.g., email address) and a password, selecting a particular online photo service, such as the Kodak EasyShare gallery, creating an email contact list, and establishing print ordering instructions. The set-up screen guides user entry of account information such as shipping address, credit card number, etc. As will be seen, the designated online photo service, email contact list and print ordering instructions will be automatically utilized for any images stored on the memory card 104 when that card is next inserted in the computer 110.

A set-up screen such as that shown in FIG. 5 may be presented to the user at a retail location where the user purchases the memory card, such that the user can complete the initial set-up with the assistance of a retail clerk. One or more of the fields of the set-up screen may be automatically populated, for example, with an account number or other information provided by the user in conjunction with purchase of the card.

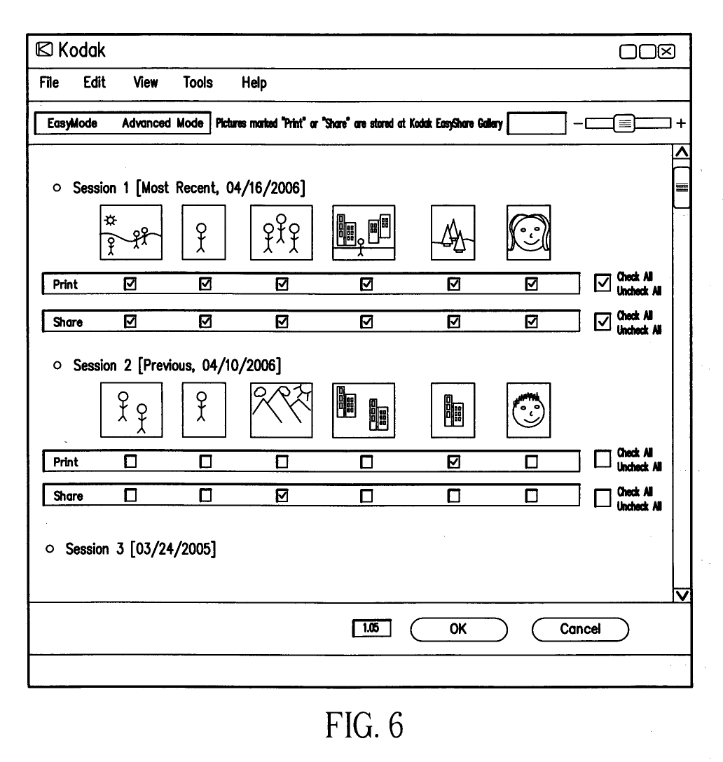

An example of an options screen that may be presented to the user in step 404 is the web page shown in FIG. 6. In this particular example, there are already a number of captured images present on the removable memory card 104 when it is first inserted into the computer 110. The options screen presents the various captured images in groups based on sessions arranged in order of date and time starting with the most recent. For each of the groups, thumbnails of the corresponding captured images are shown, along with check boxes which allow the user to designate print and sharing options on a per-image basis. Thus, in this example, two choices are presented, “Print” and “Share,” from which the user makes selections. The user has the option to more quickly select the desired images by using a “check all/uncheck all” toggle.

The options screen shown in FIG. 6 is intended to provide a quick way to move images from the memory card to an online photo service for web display, emailing, sharing and print fulfillment. Upload and storage at the designated online photo service provider is implied for pictures that are marked to Print or Share. By clicking “OK,” the user by default orders a 4×6 print of each picture selected for printing, with the total amount applied to the default credit card entered in the First Time Setup screen of FIG. 5. The use of the options screen of FIG. 6 depends on the user having completed the initial set-up for the memory card. In the options screen, all calculations and negotiations use the default information entered in the initial set-up, such as shipping address, default print ordering specifications, etc. If the user needs to change that basic information, the user may click “Setup Options” in the FIG. 6 screen to revisit the set-up screen of FIG. 5.

The options screen web page shown in FIG. 6 may also be presented upon subsequent insertions of the card, with the previously-selected options already populated for those sessions that were viewed in a previous insertion. Thus, the presentation of the sessions may be configured to as to allow the user to distinguish between images already viewed in previous insertions of the card, and new images that have been added to the card since then. As indicated above, the sessions may be organized on the screen using time and date metadata from the images. Each session may be “opened” for viewing or “closed” with a simple toggle. Default selections may be used, such as checks entered for each option for all sessions that were not previously viewed in conjunction with a prior insertion of the card.

Other types of default selections may be used, including, for example, automatic deletion of images from the card upon download of images to the computer, automatic selection of new images and deselection of old images, or automatic selection of other automatic processing operations.

The present embodiment supports the storage of images on the card, the computer, a remote storage space accessible via the Internet, or other storage medium, in any desired combination.

Additional or alternative options screens may be made available. For example, user may be permitted to bypass the simplified interface of the options screen of FIG. 6 to access options associated with more advanced features, such as multiple prints, different print sizes or finishes, different album names, aggregation or consolidation of albums, designation of multiple albums, etc. As shown at the top of the FIG. 6 screen, a toggle is provided to change between an easy mode and an advanced mode for selection of options.

An options screen such as that shown in FIG. 6 will also preferably reflect agreement with any contractual obligations of the user, such as prices to be charged for particular services. Clicking the “OK” button in this screen provides a confirmation to the system that the user has agreed to these contractual obligations. The screen may also be configured to indicate that prices may change periodically.

In step 406 of FIG. 4, the user selects processing operations for use with images that are to be stored on the card. These operations include, for example, the operations illustrated in the web page of FIG. 5, which include uploading of pictures to a particular online photo service, notifying and emailing pictures to particular designees, print ordering instructions, etc.

Step 408 indicates that application information identifying the selected processing operations is then stored in the application information storage area 306 of the removable memory card 104. Such application information can include, for example, an application allowing the computer to access the cloaked memory space of the card, and an application which automatically opens a link between the computer and a remote storage space, which could be associated with an online photo service or other Internet site. As another example, these and/or other user-selected processing operations may be provided using respective portions of a single application.

The user then removes the card from the computer 110 and inserts the card in the digital camera 102, as shown in step 410. In step 412, the user captures initial or additional images using the camera, and the camera stores the captured images in the digital image storage area 304 of the card. The user then removes the card from the digital camera as indicated in step 414.

If there are already images stored on the card at the time of its first insertion in the computer, the process may skip steps 410 through 414, and proceed directly from step 408 to steps 420 and 422 for presentation of the previously-selected processing operations and confirmation that such operations are to be applied to the images stored on the card.

Assuming that there are no images on the card at the time of the completion of the initial storage of application information in step 408, steps 410 through 414 are performed as previously described, and the process then returns to step 400, where the user again inserts the removable memory card 104 into the card reader 111 of the computer 110. As this insertion is not the first insertion of the card, step 402 results in a negative determination, and the process moves to step 420, where the user is automatically presented with previously-selected processing operations. For example, the user may be automatically presented with a web page indicating how the captured images will be processed, based on the previous selections made by the user in step 406 and the application information stored on the card in step 408. This web page may correspond, for example, a web page such as that of FIG. 5 or FIG. 6 or suitable portions thereof, populated with the previous selections. Again, the presentation of the sessions should be arranged such that the user can distinguish those sessions that have been viewed in conjunction with prior insertions of the card from those that have not yet been viewed.

As the particular processing operations previously selected by the user are stored on the given memory card, other related information, such as the user identifier and password established using the set-up screen of FIG. 5, may be stored on the card as part of the application information. Thus, such information need not be entered upon a subsequent insertion of the card in the computer. Alternatively, entry of a user identifier and password may be required in conjunction with step 402, as part of the determination that leads to the user being automatically presented with the previously-selected processing operations in step 420. It should be noted that automatic authentication mechanisms that do not rely upon entry of passwords may be used in a given embodiment of the invention. For example, a given card identifier may be paired with an identifier of a particular computer or identifiers of multiple computers during an initial set-up, such that the card is automatically authenticated upon insertion into a reader associated with one of the corresponding computers. Elimination of the need to enter a password will facilitate one-button operation in certain embodiments of the invention.

The automatic presentation of previously-selected processing operations in step 420 may be based, for example, on installation of a device driver in computer 110 from the card, or launching of a software application stored on the card. As previously indicated, such drivers and software applications are examples of application information stored in application information storage area 306 of the card 104.

The user may also be presented with an opportunity to make any desired changes in the previous settings. Thus, if the user does not agree with the previously-selected operations, the user can select different operations to be applied to the images on the card.

In step 422, the user confirms that the previously-selected operations are to be applied to the images stored on the card. This may involve, for example, making a single click to accept application of processing operations such as storage, emailing, online sharing or printing of selected images stored on the card. The selected images may be limited to those images that are part of any session or sessions that were not viewed in conjunction with a previous insertion. The user may be presented with an options screen such as that shown in FIG. 6 in order to select options on a per-image basis for any session(s) not yet viewed in a prior insertion.

The single-click confirmation in step 422 indicates an agreement on the part of the user for operation to proceed as configured. As indicated previously, it also indicates agreement with any contractual obligations of the user, such as prices to be charged for particular services.

The previously-selected processing operations are applied to the selected images in step 424. By way of example, for any images that the user has designated to print or share, clicking of an icon may initiate the upload of the selected images via the computer to a particular previously-designated online photo service provider, with corresponding sharing and printing instructions, along with encrypted customer data and credit and billing information.

More particularly, although still by way of example, selected images from the card may be stored on the computer, and then transferred by the computer over a communication link to a remote storage space, such as a storage space associated with a particular online photo service provider. One or more previously-selected processing operations may then be performed on the images at the remote storage space, for example, storing the images in one or more albums, emailing the images to designated recipients, printing the images and delivering the prints to designated recipients, creating a link between the album and the memory card, etc.

In other embodiments, the confirmation step 422 may be eliminated, and the previously-selected processing operations may be applied without requiring user confirmation. For example, any images for sessions not yet viewed on prior insertions of the card may automatically be inserted into one or more albums, or emailed to or shared online with one or more designees, or printed or otherwise processed, all based on previous selections of the user as stored in the application information storage area 306 of the memory card 104.

The user can then remove the card from the computer 110 as indicated in step 426. Subsequent insertions of the card into the computer in step 400 will again result in automatic presentation of the previously-selected processing operations in step 420. Thus, the removable memory card in this embodiment is configured to store application information which provides a type of automatic launch of particular processing operations for captured images, thereby considerably facilitating the handling of captured images on removable memory cards.

Advantageously, the embodiment described above provides enhanced ease-of-use in implementing common user workflows, such as storage, emailing, online sharing and fulfillment of print orders, for the images stored on the card. Subsequent to the initial set-up of steps 404 through 408, the autolaunch process does not require the user to launch a software application on the computer 110, or even to open a web browser to access an online photo service. Moreover, once the user has completed the set-up for given removable memory card, the particular physical location and accessible computers or other processing devices of the user are irrelevant with regard to use of the card. That is, once set-up is completed, the card can be subsequently inserted in a different computer and the automatic launch process will nonetheless result in automatic presentation of the previously-selected processing operations.

In order to facilitate rapid removal and reuse of the card, thumbnails and corresponding higher resolution images may be temporarily cached or otherwise stored on the computer until the user deletes them. Upload can continue from the higher resolution images stored on the computer, assuming an operational Internet connection, while the user is allowed to remove the card from the card reader and reuse it by, for example, inserting it back into the camera. In some cases, the card may need to be erased for reuse. This can be achieved via a user-selectable option to erase the card before removing it, once images have been cached or otherwise stored on the computer for upload. Such an option can be presented via an option screen of the type described above in the context of FIG. 6.

A number of illustrative examples of particular operating scenarios of the image processing system 100 will now be described with reference to FIGS. 7, 8 and 9.

FIG. 7 shows an exemplary arrangement of a portion of the image processing system 100 in which the computer 110 includes a portable lap-top personal computer. It is assumed that this lap-top computer incorporates a card reader for receiving a removable memory card 104. It is further assumed that the removable memory card 104 is partitioned in the manner described in conjunction with FIG. 3, has undergone initial set-up via steps 402 through 408 of FIG. 4, and has subsequently been utilized to store additional captured images as per steps 410 through 414 of FIG. 4.

Insertion of the memory card 104 in the computer 110 leads to automatic display of a web page 700 associated with a particular photo service provider 140 previously designated by the user, in this case a web site of the Kodak EasyShare Gallery. This is one example of a type of previously-selected processing operation that may be applied to captured images stored in the digital image storage area 304 of the card based on application information stored in the application information storage area 306 of the card.

As noted previously, a user confirmation as in step 422 is not required, and captured images on the card that are part of a session not previously viewed in conjunction with a prior insertion of the card may be automatically assembled into an album of the type shown on the web page 700, in accordance with the application information stored on the card. Again, other types of previously-selected processing operations, such as email notifications, online sharing and printing, can also be applied. One or more options screens may be presented to allow a user to confirm the previously-selected processing operations, or to select particular images from a new session for printing. Images selected for printing may be automatically routed by the online photo service provider to the fulfillment system 150 for image enhancement, processing, printing and shipping to the designated shipping addresses. Alternatively, the user may elect to have prints ordered through certain services be delivered for pickup at particular retailer locations.

The application information stored in storage area 306 of memory card 104 may be used, for example, to allow for simple classification of pictures within albums at the online service provider. For example, if a user stores “vacation” pictures on a dedicated card, and that card is associated with a particular online photo service provider and album via the initial set-up of steps 404 through 408 of FIG. 4, then all future images stored on the card can automatically be stored by the online photo service provider within the previously-selected “vacation” album without requiring any user action beyond the simple insertion of the card in the computer.

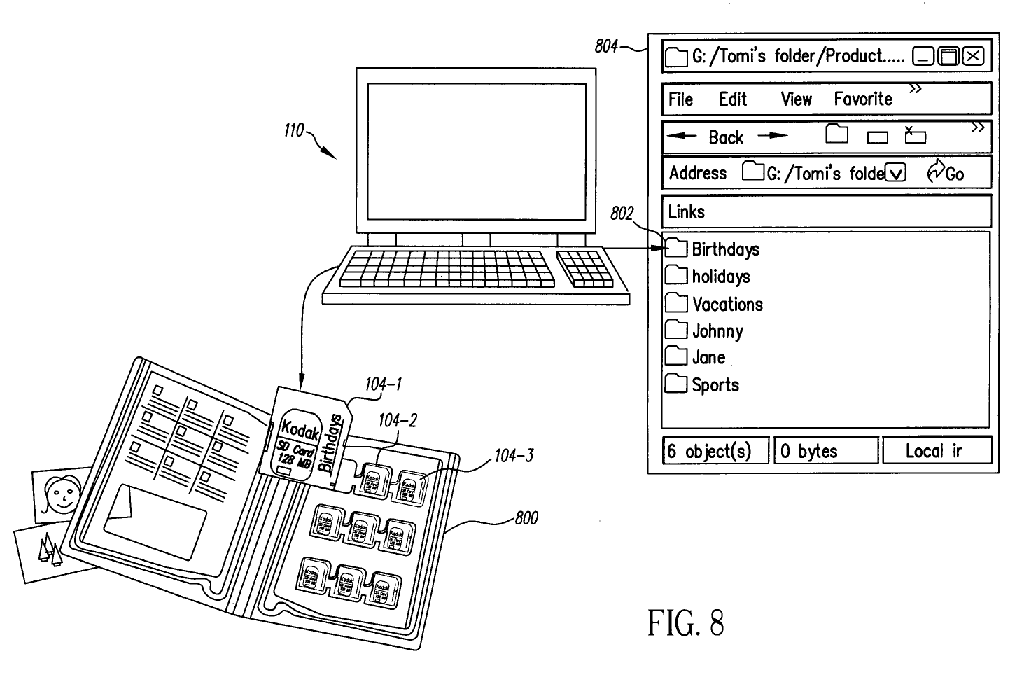

FIG. 8 illustrates an arrangement in which insertion of a particular removable memory card leads to automatic placement of the corresponding captured images in a particular file system location on the computer 110. Again, the computer 110 in this example includes a portable lap-top personal computer having a card reader. There are multiple memory cards in this example, including those denoted 104-1, 104-2 and 104-3. The various memory cards are shown as being stored in respective storage slots of a memory card storage booklet 800, which may be a Kodak PictureGuard. Each of the memory cards is associated with a particular image category. For example, memory card 104-1 is designated as being for “Birthdays.” The association of particular cards with respective categories is implemented through initial set-up of the cards via steps 402 through 408 of FIG. 4. As part of this initial set-up, each of the cards stores application information that identifies a particular file system location where any captured images on the card will automatically be stored upon insertion of the card in the computer 110.

A user selects a particular one of the memory cards 104 that is designated for a particular occasion or category. The user then inserts the selected memory card in the digital camera 102 and captures images.

Insertion of the selected memory card 104 in the computer 110 leads to automatic storage of the captured images of any new sessions since the last insertion of the card in a particular file system location on the computer 110. More specifically, by way of example, the captured images on selected memory card 104-1 are automatically stored in a Birthdays folder 802 shown in a window 804 that is presented on a display of the computer 110. This is another example of a type of previously-selected processing operation that may be applied to captured images stored in the digital image storage area 304 of the card based on application information stored in the application information storage area 306 of the card. Each of the other memory cards 104-2, 104-3 and so on in the memory card storage booklet 800 may be similarly associated with a particular image category, such that the captured images thereon are automatically stored in a corresponding folder in the file system of the computer.

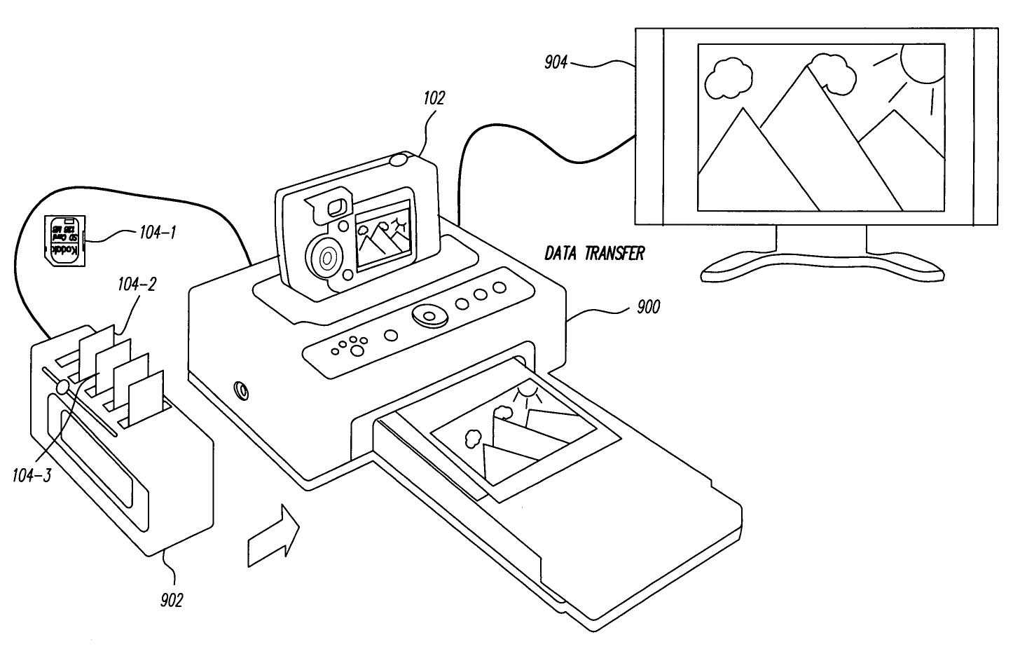

FIG. 9 shows an alternative implementation of a portion of image processing system 100 in which digital camera 102 is coupled to a printer dock 900. Also coupled to the printer dock is a multiple-slot card reader 902. The digital camera is coupled via the printer dock 900 to a monitor 904. Elements 900, 902 and 904 may be viewed as one possible alternative implementation of computer 110 of FIG. 1. In this example, multiple memory cards 104-1, 104-2, 104-3 and so on are configured in the manner previously described to include particular previously-selected processing operations to be applied to the captured images of the respective cards. Such operations in this particular implementation may include instructions for printing selected images in a particular manner via the printer dock 900 or previewing the images in a particular manner on the monitor 904.

It is to be appreciated that the particular examples shown and described in conjunction with FIGS. 7 through 9 are for purposes of illustration only, and numerous other operating scenarios involving removable memory cards with automatic launch capability may be used.

Additional details regarding the removable memory card 104 as shown in FIG. 3 will now be described. As noted above, the application information storage area 306 can include a hidden portion of the card memory, also referred to herein as a cloaked memory. This storage area stores application information, such as application programs which control the performance of previously-selected processing operations by the computer 110. Any associated user account information or other sensitive information may be stored in the storage area 306 in encrypted form. The encrypted information may be configured such that the portion of the information that is accessible upon insertion of the card depends on the particular computer, digital camera or other processing device that receives the card.

The cloaked memory may be a portion of the memory of the removable memory card that is not normally accessible by the operating system of the computer 110. As a more particular example, a file system of the computer may have accessible thereto a designated portion of the memory of the removable memory card, while the cloaked memory portion is unspecified by the file system, and thus the file system is not even aware of the existence of the cloaked memory portion. Upon insertion of the card in the computer, an application program in the application information storage area 306 may be installed on the computer so as to allow the computer to access the cloaked memory. Such an application program may be stored in firmware memory of the computer, or in another suitable storage location within the computer.

The memory card 104 may have a particular identifier that indicates to the computer 110 and digital camera 102 that the card is a cloaked memory card. Each card may also have a unique serial number or other identifier that facilitates recognition of the card as being of a particular type.

The cloaked memory may include other types of application information, such as a counter. For example, a counter could operate in conjunction with the above-noted unique card identifier to allow the computer to track events that require a limited number of operations such as number of free prints allocated to a specific card.

The cloaked memory can safely house applications that otherwise could be easily erased when a user formats the card. Such applications could cause a change in the functionality of the computer or digital camera, such as adding, removing or modifying features. By way of example, a character associated with a given holiday period may be stored in the cloaked memory and automatically superimposed on any images captured during the period. The cloaked memory could also include programs that create desired effects for the user, such as programs to create presentations, games, music, etc. A typical application program stored in the cloaked memory could be one that enables the user to easily create a presentation including captured images, music and video clips. This program could have automatic links to web sites which can take a preliminary form of this presentation and enhance it in a desired manner, for example, convert the presentation to a DVD format.

As noted above, the removable memory card 104 may utilize an MMC or SD memory card format. The manner in which the application information storage area 306 may be implemented in a card having an MMC or SD format will now be described with reference to FIGS. 10A and 10B. In this example, the application information storage area 306 is implemented in what is referred to as a private block of the card.

FIG. 10A shows a table illustrating the various fields of a first sector of a private block in the MMC or SD memory card format. The first sector is also referred to as a private block header. In this exemplary format, the fields of the private block header include a 32-bit type/use field which denotes the type/use of the corresponding private block, a 32-bit length field which indicates the length of the private block in sectors, and a 192-bit private block validation signature field. The private block sectors are not viewable to the operating system of the computer. Only applications that have the ability to physically access the card will have access to the private block.

The first sector of the private block is located in a portion of the card memory beyond a calculated size (C_SIZE+1) based on contents of a conventional C_SIZE register, or what is reported to the computer operating system as the Total Number of Sectors. Since relative sector addresses begin with zero, the address of the first sector of the private block is denoted by the value reported as the Total Number of Sectors.

The C_SIZE register is usually queried during the format process for a given card, and in some cases an existing partition table may be used. Since the card is assumed to be no larger than the C_SIZE+1 value, the format process should not overwrite the private block sectors.

The length of the private block is given in the number of sectors available. This can be as little as the calculated value of the C_SIZE_MULT field to as many as the size of the card minus the card format areas if some visibility to the operating system is required.

The private block validation signature is comprised of 24 bytes of hexadecimal data, and is used to validate that this is indeed a private block and can be used as such.

FIG. 10B illustrates in greater detail the private block type/use field of the private block first sector of FIG. 10A. This field includes a write access indicator, a data/application indicator, an encryption type indicator, and an encrypted (Y/N) indicator. Thus, this particular format supports encryption for the application information stored in storage area 306.

It should be understood that the particular private block arrangement and format described above is merely one example of how a removable memory card can be configured to include a cloaked memory portion for storing application information. Numerous other formats and card types may be used. As another example, a proposed feature negotiation function of the Personal Storage Class (PSC) standard of the USB-IF (USB Implementers Forum) organization may be used to provide a type of cloaked memory in other embodiments of the present invention.

The illustrative embodiments described above provide an improved approach to configuring storage space on a memory card, resulting in a cloaked memory space that is safe from being erased when the card is re-formatted, can easily be adjusted in size, can be used for storage of confidential information, and can include multiple sectors associated with different processing operations or other characteristics for different types or categories of images.

A memory card with a cloaked memory space as described herein advantageously allows single-button or few-button operation in a computer to provide features such as automatic storage of images in particular locations on the computer, automatic opening of links to remote storage spaces and uploading of images to those spaces, automatic e-mailing to a list of addresses, and automatic printing and delivery to a preselected location (residential or business, e.g., retailer), while also allowing adjustment for variable order data such as price per print, promotions, shipping costs, etc.

The illustrative embodiments also provide automatic organizing of images (based on factors such as event, person, location, etc). Processing operations can be designated by, for example, selecting a specific card whose content goes to a specific storage location. Based on application information stored in the cloaked memory space, the computer distributes the images to the appropriate storage locations. As another example, cards with multiple sectors can automatically collect images with a sector designated for specific camera, e.g., images taken by Jim's camera are stored in sector 1; images taken by Mary's camera are stored in sector 2, etc. Before a given memory card is inserted in the digital camera, the user can identify these and numerous other types of exemplary processing operations to be applied to any captured images that will be stored on the card.

As indicated above, the present invention can be implemented at least in part in the form of software that is executed by a computer, a digital camera or another type of processing device in an image processing system. A computer program product in accordance with the present invention can include a storage medium including one or more of the following: magnetic storage media such as magnetic disk (e.g., floppy disk) or magnetic tape; optical storage media such as optical disk, optical tape, or machine readable bar code; solid-state electronic storage devices such as RAM or ROM; or any other physical device or media employed to store a computer program having instructions for practicing a method according to the present invention.

The invention has been described in detail with particular reference to certain preferred embodiments thereof, but it will be understood that variations and modifications can be effected within the spirit and scope of the invention. For example, the particular configuration of a given removable memory card and its associated application information storage area as shown in FIG. 3 can be varied in alternative embodiments, to provide a wide variety of different types of user customization. Also, the particular elements of the image processing system 100 as shown in FIG. 1 and the digital camera as shown in FIG. 2 may be replaced with or supplemented by additional or alternative elements in other embodiments. Furthermore, the automatic launch process operations of FIG. 4 may be varied to accommodate the needs of other image processing systems and operating scenarios. These and other alternative embodiments will be readily apparent to those skilled in the art.

### PARTS LIST

100 image processing system
102 digital camera
104 removable memory card
105 dock
110 computer
111 card reader
112 CPU motherboard
114 monitor
116 keyboard
118 mouse
120 hard drive
122 modem
124 printer
130 Internet service provider
132 modems
134 computers/routers
136 channel
140 photo service provider
142 Internet server
144 service provider database
146 billing system
148 bill issuing
150 fulfillment system
152 production controller
154 color printer
156 photo product
160 disc writer
170 shipping system
172 shipping label printer
174 shipping label
202 zoom lens
204 zoom and focus motors
205 image sensor
206 clock drivers
208 control processor and timing generator circuit
210 image processor
211 user controls
212 flash
216 ASP & A/D converter circuit
218 DRAM buffer memory
220 firmware memory
222 memory card interface
224 RAM memory
225 color image display
226 video driver
228 television monitor
230 host interface
300 memory
302 partition
304 digital image storage area
306 application information storage area
400-426 process steps
700 web page
800 memory card storage booklet
802 folder
804 window
900 printer dock
902 card reader
904 monitor

What is claimed is:

1. A removable storage device configured for use with a processing device of an image processing system, the removable storage device comprising:
a first storage area configured for storing digital images; and
a second storage area partitioned from the first storage area and configured for storing user-customized application information for directing the processing of one or more of the stored digital images by the processing device upon insertion of the removable storage device in a reader associated with the processing device.

2. The storage device of claim 1 wherein said storage device comprises a memory card configured for insertion into a memory card slot of said processing device.

3. The storage device of claim 1 wherein said processing device comprises a digital camera.

4. The storage device of claim 1 wherein said processing device comprises a computer.

5. The storage device of claim 1 wherein the second storage area comprises a cloaked memory not otherwise accessible to an operating system of the processing device without first providing at least a portion of the application information to the processing device.

6. The storage device of claim 1 wherein the second storage area comprises a private block of the removable storage device.

7. The storage device of claim 6 wherein a first sector of the private block begins at an address given by a value of a reported total number of sectors of the storage device.

8. The storage device of claim 6 wherein a first sector of the private block comprises a private block header, the private block header comprising a type or use indicator field, a private block length field and a private block validation signature field.

9. The storage device of claim 1 wherein said application information comprises information identifying at least one particular processing operation that is previously selected by a user in conjunction with an automatic launch set-up process and that is to be automatically applied to one or more of the stored images by the processing device, upon insertion of the removable storage device in the reader, without further intervention by the user.

10. The storage device of claim 9 wherein said particular processing operation comprises at least one of a storing operation, a printing operation, an emailing operation and an online sharing operation.

11. The storage device of claim 9 wherein the particular processing operation is designated for application to only those of the stored images that are associated with one or more specified sessions for which corresponding stored images have not been previously processed in conjunction with a prior insertion of the storage device.

12. The storage device of claim 1 wherein said application information comprises a software program directing the processing of one or more of the stored images by the processing device.

13. The storage device of claim 1 wherein said application information directs the processing device to upload one or more of the images to a designated service provider for storage.

14. The storage device of claim 1 wherein said application information directs the processing device to store one or more of the images in a particular file system location on the processing device.

15. The storage device of claim 1 wherein said application information directs the processing device to control the printing of one or more of the images in a particular manner.

16. The storage device of claim 1 wherein said application information directs the processing device to control the presentation of one or more of the images in a particular manner.

17. The storage device of claim 1 wherein at least a portion of said application information is stored in an encrypted form.

18. A processing device having an associated reader for a removable storage device, the processing device comprising:
a processor; and
a memory coupled to the processor;
wherein the processing device is operative to process one or more digital images stored on the removable storage device in accordance with user-customized application information stored in an application information storage area of the removable storage device, upon insertion of the removable storage device in the reader, the application information storage area of the removable storage device being partitioned from a digital image storage area of the removable storage device.

19. The processing device of claim 18 wherein said reader is a component of said processing device.

20. An image processing system comprising:
a digital camera;
a processing device; and
a removable storage device configured for use with the digital camera and the processing device;
the removable storage device comprising a first storage area configured for storing digital images captured using the digital camera, and a second storage area partitioned from the first storage area and configured for storing user-customized application information for directing the processing of one or more of the stored digital images by the processing device upon insertion of the removable storage device in a reader associated with the processing device.
